(19) United States
(12) Patent Application Publication
(10) Pub. No.: US 2025/0063306 A1
(43) Pub. Date: Feb. 20, 2025

(54) SPEAKER AND VOICE COIL MODULE THEREOF

(71) Applicant: Eastech (Huizhou) Co., Ltd., Guangdong (CN)

(72) Inventor: Junming CHEN, Guangdong (CN)

(21) Appl. No.: 18/805,554

(22) Filed: Aug. 15, 2024

(30) Foreign Application Priority Data
Aug. 18, 2023 (CN) 202322241101.5

(51) Int. Cl. H04R 9/04; H04R 7/06; H04R 9/02; H04R 9/06

(52) U.S. Cl. CPC H04R 9/045; H04R 7/06; H04R 9/025; H04R 9/06; H04R 2307/021; H04R 2400/11

(57) ABSTRACT

A voice coil module includes a plate body and a voice coil wire. The voice coil wire is wrapped from a first surface of the plate body to a second surface of the plate body, and then the voice coil wire is wrapped from the second surface of the plate body back to the first surface of the plate body.

### RELATED APPLICATIONS

This application claims priority to China Patent Application No. 202322241101.5, filed Aug. 18, 2023, the entirety of which is herein incorporated by reference.

### BACKGROUND

### Field of Invention

The present invention relates to hardware architectures, and more particularly, a speaker and its voice coil module.

### Description of Related Art

Music is an important product of human civilization. With the improvement of people's living standards, the types of music-related devices have become more and more diversified. Among them, the speaker is an important device that can effectively increase the sound volume. In addition to its application in music, users can also use the speaker to allow more listeners to hear the message that the user wants to publish.

The traditional voice coil is a single planar winding. However, the single planar winding does not have enough turns, and the effect is not good. If the number of turns in the single planar winding is increased, the area of the voice coil will be greatly increased and it will be difficult to assemble.

### SUMMARY

In one or more various aspects, the present disclosure is directed to a speaker to solve the problems of the prior art.

One embodiment of the present disclosure is related to a voice coil module, which includes a plate body and a voice coil wire. The voice coil wire is wrapped from a first surface of the plate body to a second surface of the plate body, and then the voice coil wire is wrapped from the second surface of the plate body back to the first surface of the plate body.

In one embodiment of the present disclosure, the plate body is a printed circuit board.

In one embodiment of the present disclosure, the plate body includes a plurality of perforations, the voice coil wire is wrapped from the first surface of the plate body to the second surface of the plate body through one of the perforations, and the voice coil wire is wrapped from the second surface of the plate body to the first surface of the plate body through another one of the perforations.

In one embodiment of the present disclosure, a part of the voice coil wire positioned on the first surface of the plate body acts as a first surface wire, another part of the voice coil wire positioned on the second surface of the plate body acts as a second surface wire, and a trajectory of the first surface wire is different from a trajectory of the second surface wire.

In one embodiment of the present disclosure, the plate body includes a plurality of openings disconnected from the voice coil wire.

Another embodiment of the present disclosure is related to a speaker, which includes a basket, at least one voice coil module, at least one magnetic component and at least one drum paper. The at least one voice coil module is disposed in the basket. The at least one voice coil module includes a plate body and a voice coil wire, the voice coil wire wrapped from a first surface of the plate body to a second surface of the plate body, and then the voice coil wire wrapped from the second surface of the plate body back to the first surface of the plate body. The at least one magnetic component is disposed on the plate body of the at least one voice coil module. The at least one drum paper is disposed on the basket.

In one embodiment of the present disclosure, the speaker further includes at least one supporting frame disposed in the basket, and the at least one supporting frame is disconnected from the at least one voice coil module.

In one embodiment of the present disclosure, the at least one voice coil module includes a plurality of voice coil modules, the at least one magnetic component includes a plurality of magnetic components, every two magnetic components of the plurality of magnetic components are disposed respectively on the first surface and the second surface of the plate body of each of the plurality of voice coil modules, the at least one supporting frame includes a plurality of supporting frames, and the plurality of the supporting frames and the plurality of the voice coil modules are staggered alternately.

In one embodiment of the present disclosure, the at least one drum paper includes two drum papers, the two drum papers are arranged on opposite sides of the basket, and the at least one voice coil module is disposed between the two drum papers.

In one embodiment of the present disclosure, the plate body is a printed circuit board.

Another embodiment of the present disclosure is related to a speaker, which includes a basket, a plurality of voice coil modules and a plurality of magnetic components. The plurality of voice coil modules is disposed in the basket, where each of the plurality of the voice coil modules includes a plate body and a voice coil wire, the voice coil wire is wrapped from a first surface of the plate body to a second surface of the plate body, and then the voice coil wire is wrapped from the second surface of the plate body back to the first surface of the plate body. Every two magnetic components of the plurality of magnetic components are disposed respectively on the first surface and the second surface of the plate body of each of the plurality of voice coil modules.

In one embodiment of the present disclosure, the speaker further includes a plurality of supporting frames disposed in the basket, and the plurality of the supporting frames are disconnected from the plurality of the voice coil modules.

In one embodiment of the present disclosure, the plurality of the supporting frames and the plurality of the voice coil modules are staggered alternately.

In one embodiment of the present disclosure, the speaker further includes two drum papers arranged on opposite sides of the basket, and the plurality of the voice coil modules are disposed between the two drum papers.

In one embodiment of the present disclosure, a part of the voice coil wire positioned on the first surface of the plate body acts as a first surface wire, another part of the voice coil wire positioned on the second surface of the plate body acts as a second surface wire, and a trajectory of the first surface wire is different from a trajectory of the second surface wire.

Technical advantages are generally achieved, by embodiments of the present disclosure. The voice coil module of the present disclosure effectively increases the number of induction coils. The speaker using the voice coil module of the present disclosure achieves a low-frequency effect with large amplitude. The voice coil module of the present disclosure can reduce and improve the segmentation vibration of the speaker (such as a flat speaker).

Many of the attendant features will be more readily appreciated, as the same becomes better understood by reference to the following detailed description considered in connection with the accompanying drawings.

### BRIEF DESCRIPTION OF THE DRAWINGS

The invention can be more fully understood by reading the following detailed description of the embodiment, with reference made to the accompanying drawings as follows:

FIG. 1 is a perspective plan view of a voice coil module according to one embodiment of the present disclosure;

FIG. 2 is an exploded view of a speaker according to one embodiment of the present disclosure;

FIG. 3 is a top view of the speaker according to one embodiment of the present disclosure; and

FIG. 4 is a partially perspective view of the speaker according to one embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

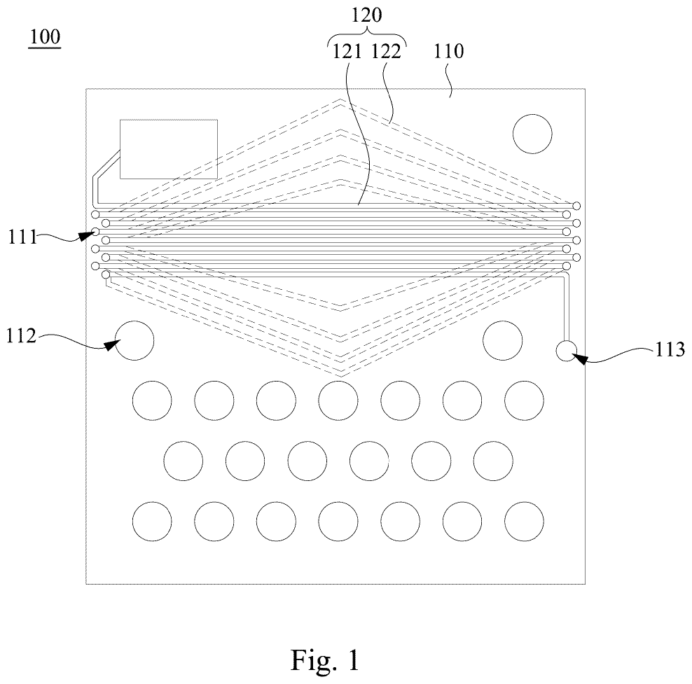

Referring to FIG. 1, in one aspect, the present disclosure is directed to a voice coil module 100. This passive radiator module can be applied to various types of speakers and may be applicable or readily adaptable to all technologies. Accordingly, the voice coil module 100 has advantages. Herewith the voice coil module 100 is described below with FIG. 1.

The subject disclosure provides the voice coil module 100 in accordance with the subject technology. Various aspects of the present technology are described with reference to the drawings. In the following description, for purposes of explanation, numerous specific details are set forth in order to provide a thorough understanding of one or more aspects. It can be evident, however, that the present technology can be practiced without these specific details. In other instances, well-known structures and devices are shown in block diagram form in order to facilitate describing these aspects. The word “exemplary” is used herein to mean “serving as an example, instance, or illustration.” Any embodiment described herein as “exemplary” is not necessarily to be construed as preferred or advantageous over other embodiments.

FIG. 1 is a perspective plan view of the voice coil module 100 according to one embodiment of the present disclosure. As shown in FIG. 1, the voice coil module 100 includes a plate body 110 and a voice coil wire 120. In structure, the voice coil wire 120 is wrapped from the first surface of the plate body 110 to the second surface of the plate body, and then the voice coil wire 120 is wrapped from the second surface of the plate body 110 back to the first surface of the plate body 110. Through the double-sided winding mechanism, the voice coil module 100 of the present disclosure can effectively increase the number of induction coils and reduce the area of the plate body 110.

Specifically, in some embodiments of the present disclosure, a part of the voice coil wire 120 positioned on the first surface (such as the front surface) of the plate body 110 acts as the first surface wire 121, and another part of the voice coil wire 120 positioned on the second surface (such as the back surface) of the plate body 110 acts as the second surface wire 122. The trajectory of the first surface wire 121 is different from the trajectory of the second surface wire 122 so as to prevent the electromagnetic forces from canceling each other when the voice coil wire 120 is energized. As shown in FIG. 1, in practice, for example, the trajectory of the first surface wire 121 is horizontal lines, and the trajectory of the second surface wire 122 is polylines.

Regarding the specific manner in which the voice coil wire 120 passes back and forth through the first and second surfaces of the plate body 110, in some embodiments of the present disclosure, the plate body 110 has perforations 111, the voice coil wire 120 is wrapped from the first surface of the plate body 110 to the second surface of the plate body 110 through one of the perforations 111, and then the voice coil wire 120 is wrapped from the second surface of the plate body 110 to the first surface of the plate body 110 through another one of the perforations 111. Alternatively, in some embodiments of the present disclosure, the voice coil wire 120 is wrapped from the first surface of the plate body 110 through one side edge of the plate body 110 to the second surface of the plate body 110, and then the voice coil wire 120 is wrapped from the second surface of the plate body 110 through another side edge of the plate body 110 to the first surface of the plate body 110.

In some embodiments of the present disclosure, the plate body 110 has a plurality of openings 112, and the openings 112 are disconnected from the voice coil wire 120. The diameter of the opening 112 is larger than the diameter of the perforation 111. The arrangement of the openings 112 reduces the weight of the plate body 110 and increases air circulation.

In some embodiments of the present disclosure, the plate body 110 is a printed circuit board. Although there is only one plate body 110 in FIG. 1, this does not limit the present disclosure. In practice, the plate body 110 can be a single-layer plate body or a multi-layer plate body. For example, the plate body 110 can be a plurality of printed circuit boards stacked together or a printed circuit board with a multi-layer plate body structure. In some embodiments of the present disclosure, the voice coil wire 120 can be connected from the connection hole 113 of the plate body 110 to the next plate body. The first and second surfaces of the next plate body can be wrapped through above back and forth manner so as to further increase the number of induction coils.

In practice, for example, the voice coil wire 120 can be electrically connected to a peripheral circuit of the printed circuit board, and can also be electrically connected to an external circuit. It should be understood that in this article, the description of “electrical connection” can generally refer to one component being indirectly electrically coupled to another component through other components, or one component being directly electrically connected to another component without going through another component. For example, one end of the voice coil wire 120 can be directly electrically connected to an external circuit, or one end of the voice coil wire 120 can be indirectly connected to the external circuit through a conducting wire.

In view of the above, the voice coil module 100 of the present disclosure effectively increases the number of induction coils, without increasing the area of the plate body 110.

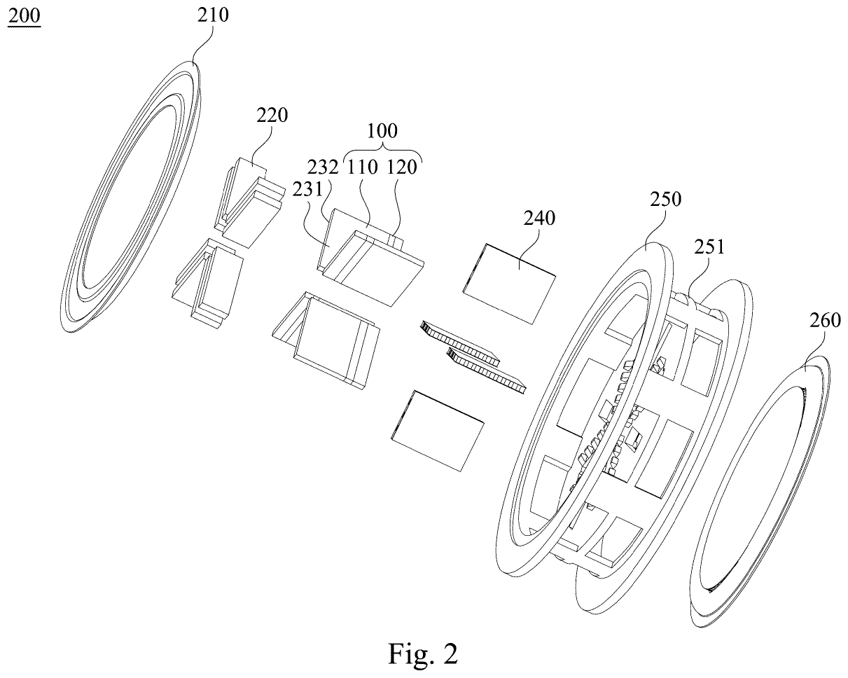

FIG. 2 is an exploded view of a speaker 200 according to one embodiment of the present disclosure. As shown in FIG. 2, the voice coil module 100 in FIG. 1 is suitable for the speaker 200 in FIG. 2. In practice, for example, the speaker 200 can be used as a flat speaker, but the present disclosure is not limited thereto.

Referring to FIG. 1 and FIG. 2, in some embodiments of the present disclosure, the speaker 200 includes a basket 250, the voice coil module 100, a magnetic component 220 (such as magnet) and at least one of drum papers 210 and 260. In structure, the voice coil module 100 is disposed in the basket 250. The voice coil module 100 includes the plate body 110 and the voice coil wire 120. The voice coil wire 120 is wrapped from the first surface 231 of the plate body 110 to the second surface 232 of the plate body 110, and then the voice coil wire 120 is wrapped from the second surface 232 of the plate body 110 back to the first surface 231 of the plate body 110. The magnetic component 220 is disposed on the plate body 110 of the voice coil module 100. The drum papers 210 and 260 are arranged on basket 250.

In some embodiments of the present disclosure, two drum papers 210 and 260 are disposed on opposite sides of the basket 250, and the voice coil module 100 is disposed between the two drum papers 210 and 260. The two drum papers 210 and 260 are arranged in parallel approximately, so that the speaker 200 can be used as a flat speaker.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

In some embodiments of the present disclosure, the speaker 200 further includes a supporting frame 240. The supporting frame 240 is disposed in the basket 250, and the supporting frame 240 is disconnected from the voice coil module 100. Through the arrangement of the supporting frame 240, the overall structure of the speaker 200 is made more stable.

In some embodiments of the present disclosure, the number of voice coil modules 100 is plural, and the number of magnetic components 220 is plural. Every two magnetic components 220 of the plurality of magnetic components 220 are disposed respectively on the first surface 231 and the second surface 232 of the plate body 110 of each of the plurality of voice coil modules 100. In practice, for example, on the voice coil module 100, the voice coil wires 120 are disconnected from the magnetic components 220, and the magnetic component 220 is positioned adjacent to the voice coil module 100.

In some embodiments of the present disclosure, the number of the supporting frames 240 is plural, and the supporting frames 240 and the voice coil modules 100 are staggered alternately. The basket 250 has a fixed platform 251 in the middle to fix the supporting frames 240 and the voice coil modules 100.

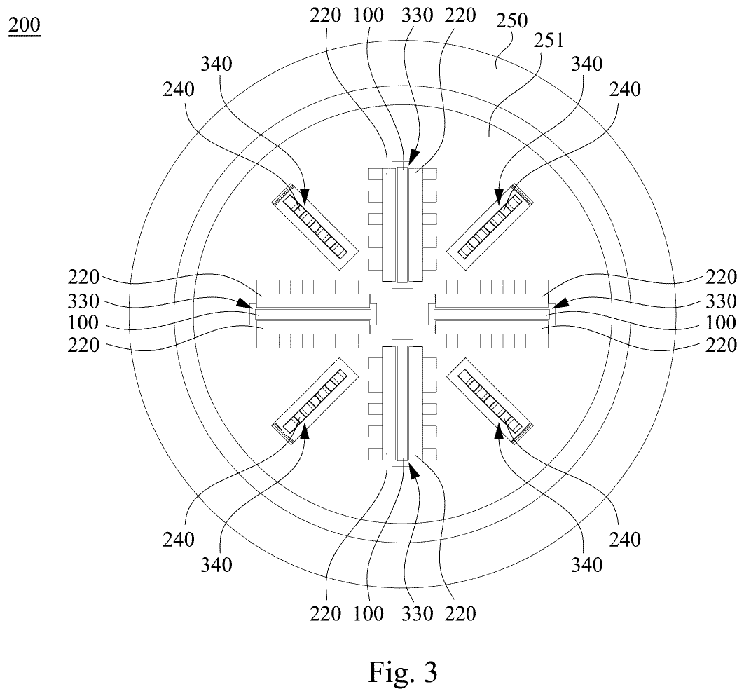

In order to further elaborate on the specific structure of the fixed platform 251 in the middle of the above basket 250, please refer to FIG. 3. FIG. 3 is a top view of the speaker 200 according to one embodiment of the present disclosure. It should be understood that the drum papers 210 and 260 in FIG. 2 are omitted in FIG. 3 to facilitate the explanation of the structure of the fixed platform 251.

As shown in FIG. 3, the fixed platform 251 in the middle of the basket 250 has one or more supporting frame sockets 340 and one or more voice coil sockets 330. In structure, the supporting frames 240 are respectively disposed in the supporting frame sockets 340. Each voice coil module 100 is provided with two magnetic components 220 on two opposite sides. Each voice coil module 100 and the magnetic components 220 on both sides thereof are disposed in a corresponding one of the voice coil sockets 330.

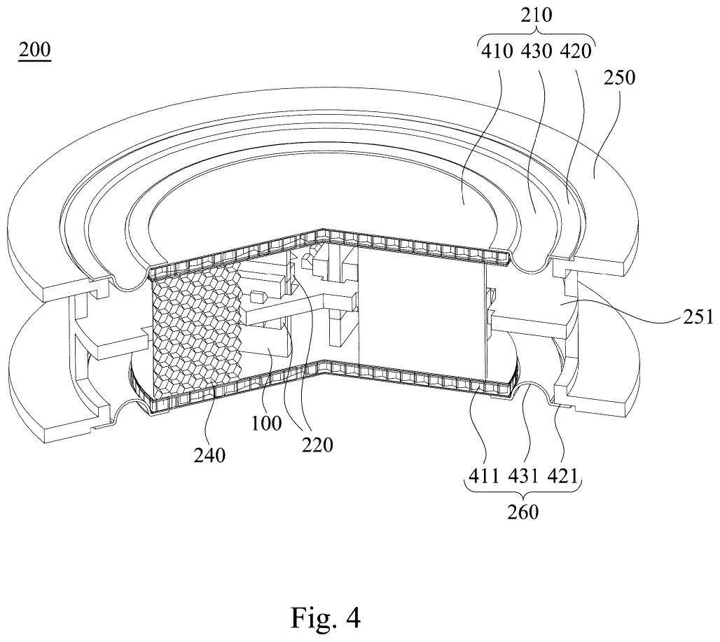

In order to further elaborate on the internal structure of the above speaker 200 after assembly, please refer to FIG. 4. FIG. 4 is a partially perspective view of the speaker 200 according to one embodiment of the present disclosure. It should be noted that part of the external structure is omitted in FIG. 3 to facilitate the description of the internal structure of speaker 200 after assembly.

As shown in FIG. 4, the drum paper 210 includes a diaphragm 410 and a hanging edge 420. In structure, the diaphragm 410 is positioned above the supporting frames 240 and the voice coil modules 100. The diaphragm 410 is connected to the hanging edge 420, and the hanging edge 420 is bonded to the basket 250 (e.g., through adhesion).

In some embodiments of the present disclosure, the hanging edge 420 can be a concave ring hanging edge having a surround 430. The cross-sectional shape of the surround 430 in FIG. 4 is concave, but this does not limit the present disclosure. In other embodiments of the present disclosure, the surround 430 can also be an annular structure, and its cross-sectional shape can be annular, convex, wavy, triangle, square, polygon or a combination of the above, depending on the design of the speaker 200.

As shown in FIG. 4, the drum paper 260 includes a diaphragm 411 and a hanging edge 421. In structure, the diaphragm 411 is positioned under the supporting frames 240 and the voice coil modules 100. The diaphragm 411 is connected to the hanging edge 421, and the hanging edge 421 is bonded to the basket 250 (e.g., through adhesion).

In some embodiments of the present disclosure, the hanging edge 421 may be a concave ring hanging edge having a surround 431. The cross-sectional shape of the surround 431 in FIG. 4 is concave, but this does not limit the present disclosure. In other embodiments of the present disclosure, the surround 431 can also be an annular structure, and its cross-sectional shape can be annular, convex, wavy, triangle, square, polygon or a combination of the above, depending on the design of the speaker 200.

When the speaker 200 operates, the voice coil module 100 is the drive unit of the speaker 200. When a current that carries acoustic information and changes from time to time is passed through the voice coil module 100, magnetic fields in different directions can be generated at one moment and the next moment. The voice coil module 100 can vibrate up and down according to the changes in magnetic force, thereby driving the drum papers 210 and 260 and their hanging edges 420 and 421 vibrate back and forth, causing the speaker 200 to emit sound.

Through the structure of speaker 200, a flatter and wider BL parameter can be obtained. The BL parameter (i.e., magnetic strength) is the product of the gap magnetic induction intensity and the effective voice coil wire length. Since the BL width of speaker 200 is wider and flatter, the total harmonic distortion (THD) of speaker 200 will be relatively lower.

In view of the above, technical advantages are generally achieved, by embodiments of the present disclosure. The voice coil module 100 of the present disclosure effectively increases the number of induction coils. The speaker 200 using the voice coil module 100 of the present disclosure achieves a low-frequency effect with large amplitude. The voice coil module 100 of the present disclosure can reduce and improve the segmentation vibration of the speaker 200 (such as a flat speaker).

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A voice coil module, comprising:
a plate body; and
a voice coil wire wrapped from a first surface of the plate body to a second surface of the plate body, and then the voice coil wire wrapped from the second surface of the plate body back to the first surface of the plate body.

2. The voice coil module of claim 1, wherein the plate body is a printed circuit board.

3. The voice coil module of claim 1, wherein the plate body comprises a plurality of perforations, the voice coil wire is wrapped from the first surface of the plate body to the second surface of the plate body through one of the perforations, and the voice coil wire is wrapped from the second surface of the plate body to the first surface of the plate body through another one of the perforations.

4. The voice coil module of claim 1, wherein a part of the voice coil wire positioned on the first surface of the plate body acts as a first surface wire, another part of the voice coil wire positioned on the second surface of the plate body acts as a second surface wire, and a trajectory of the first surface wire is different from a trajectory of the second surface wire.

5. The voice coil module of claim 1, wherein the plate body comprises a plurality of openings disconnected from the voice coil wire.

6. A speaker, comprising:
a basket;
at least one voice coil module disposed in the basket, the at least one voice coil module comprising a plate body and a voice coil wire, the voice coil wire wrapped from a first surface of the plate body to a second surface of the plate body, and then the voice coil wire wrapped from the second surface of the plate body back to the first surface of the plate body;
at least one magnetic component disposed on the plate body of the at least one voice coil module; and
at least one drum paper disposed on the basket.

7. The speaker of claim 6, further comprising:
at least one supporting frame disposed in the basket, and the at least one supporting frame disconnected from the at least one voice coil module.

8. The speaker of claim 7, wherein the at least one voice coil module comprises a plurality of voice coil modules, the at least one magnetic component comprises a plurality of magnetic components, every two magnetic components of the plurality of magnetic components are disposed respectively on the first surface and the second surface of the plate body of each of the plurality of voice coil modules, the at least one supporting frame comprises a plurality of supporting frames, and the plurality of the supporting frames and the plurality of the voice coil modules are staggered alternately.

9. The speaker of claim 6, wherein the at least one drum paper comprises two drum papers, the two drum papers are arranged on opposite sides of the basket, and the at least one voice coil module is disposed between the two drum papers.

10. The speaker of claim 6, wherein the plate body is a printed circuit board.

11. A speaker, comprising:
a basket;
a plurality of voice coil modules disposed in the basket, wherein each of the plurality of the voice coil modules comprising a plate body and a voice coil wire, the voice coil wire wrapped from a first surface of the plate body to a second surface of the plate body, and then the voice coil wire wrapped from the second surface of the plate body back to the first surface of the plate body; and
a plurality of magnetic components, wherein every two magnetic components of the plurality of magnetic components are disposed respectively on the first surface and the second surface of the plate body of each of the plurality of voice coil modules.

12. The speaker of claim 11, further comprising:
a plurality of supporting frames disposed in the basket, and the plurality of the supporting frames are disconnected from the plurality of the voice coil modules.

13. The speaker of claim 12, wherein the plurality of the supporting frames and the plurality of the voice coil modules are staggered alternately.

14. The speaker of claim 13, further comprising:
two drum papers arranged on opposite sides of the basket, and the plurality of the voice coil modules are disposed between the two drum papers.

15. The speaker of claim 11, wherein a part of the voice coil wire positioned on the first surface of the plate body acts as a first surface wire, another part of the voice coil wire positioned on the second surface of the plate body acts as a second surface wire, and a trajectory of the first surface wire is different from a trajectory of the second surface wire.
